(19) United States
(12) Patent Application Publication
(10) Pub. No.: US 2024/0316974 A1
(43) Pub. Date: Sep. 26, 2024

(54) PRINTING PROCESS

(71) Applicant: BERRY GLOBAL, INC., Evansville, IN (US)

(72) Inventors: Joseph M. DEWIG, Mount Vernon, IN (US); Shawn A. HYNEMAN, Evansville, IN (US); Russell SCHWARTZ, Parsippany, NJ (US); Nigel CAIGER, Bath (GB); Damian WARD, Bath (GB); Richard BAKER, West Lebanon, NH (US)

(21) Appl. No.: 18/610,854

(22) Filed: Mar. 20, 2024

Related U.S. Application Data
(60) Provisional application No. 63/453,610, filed on Mar. 21, 2023.

(51) Int. Cl. B41M 5/00; B41J 2/48; B41M 5/025

(52) U.S. Cl. CPC B41M 5/0064; B41J 2/48; B41M 5/0047; B41M 5/0256

(57) ABSTRACT

A method of printing on a polymeric article includes applying a decoration-forming deposit on a transfer unit. The method further includes transferring the decoration-forming deposit from the transfer unit to the polymeric article to provide a decoration on the polymeric article.

### PRIORITY CLAIM

This application claims priority under 35 U.S.C. § 119(e) to U.S. Provisional Patent Application No. 63/453,610, filed Mar. 21, 2023, which is expressly incorporated by reference herein in its entirety.

### BACKGROUND

The present disclosure relates to printing, and particularly to printing on plastic materials. More particularly, the present disclosure relates to ink jet printing on plastic materials.

### SUMMARY

According to the present disclosure, a digital print system is configured to provide decorations on polymeric articles through a digital printing process. The digital print system includes a rotary carrier, a printing unit, and a thermal-control unit. The printing unit includes a support wheel and a plurality of transfer units coupled to the support wheel for rotation about an axis with the support wheel. The rotary carrier continuously rotates about the axis to move each transfer unit past the printing unit and the thermal-control unit during the digital printing process.

In illustrative embodiments, the digital printing process includes thinning an ink solution and injecting the ink solution on the transfer unit using an inkjet printer head. The digital printing process may further include cooling, at least partially, the decoration-forming deposit after the step of applying the decoration-forming deposit on the transfer unit. The decoration-forming deposit may then be transferred from each transfer unit to a polymeric article to decorate the polymeric article.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a flowchart of a process for digital printing on a polymeric article, in accordance with the present disclosure, showing that the process includes the steps preparing an ink solution, heating the ink solution, applying a decoration-forming deposit on a transfer unit, cooling the decoration-forming deposit, and transferring the cooled decoration-forming deposit from the transfer unit to the polymeric article to produce a decorated article that may be packaged and transported;

FIG. 2 is a diagrammatic view of a digital print system configured to produce the decorated article from FIG. 1 by digital printing; and

FIG. 3 is a flowchart of another process for digital printing on a polymeric article in accordance with the present disclosure.

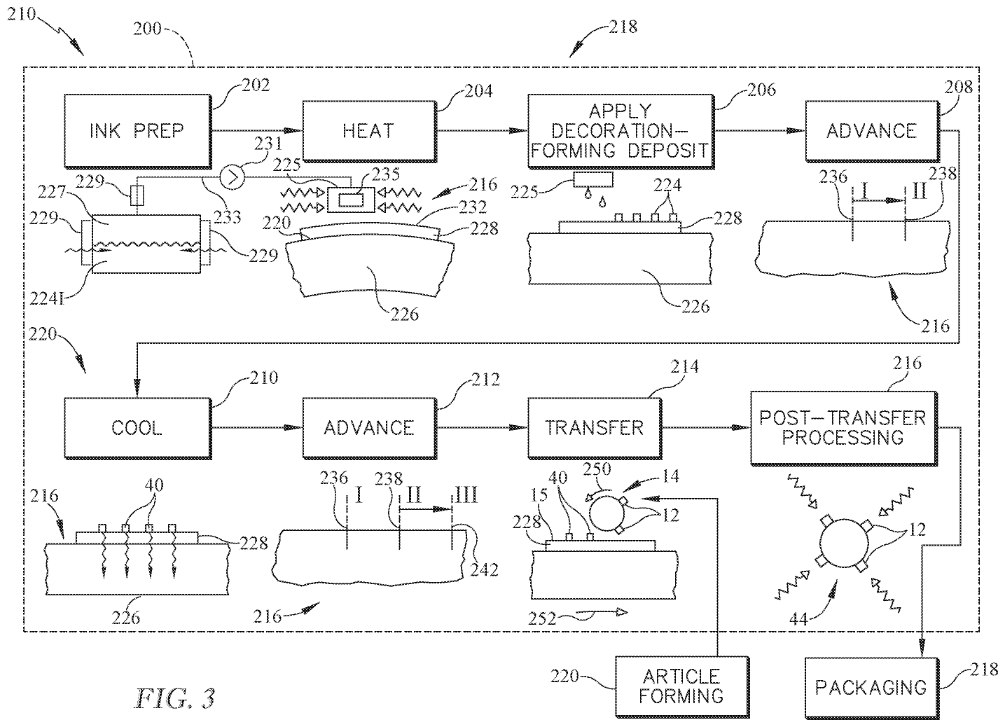

### DETAILED DESCRIPTION

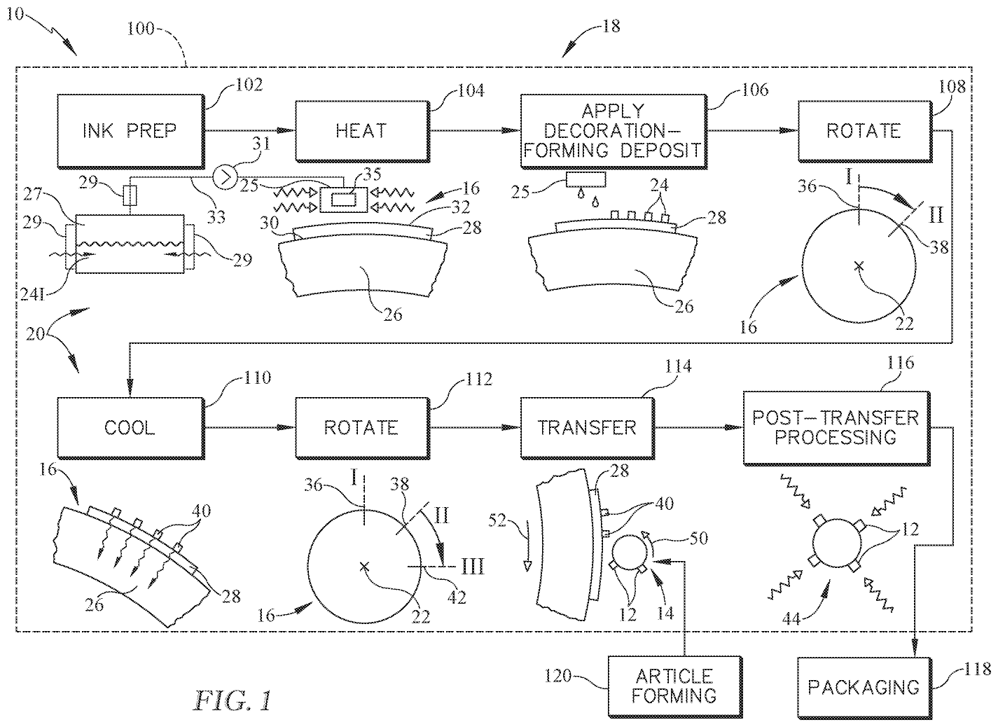

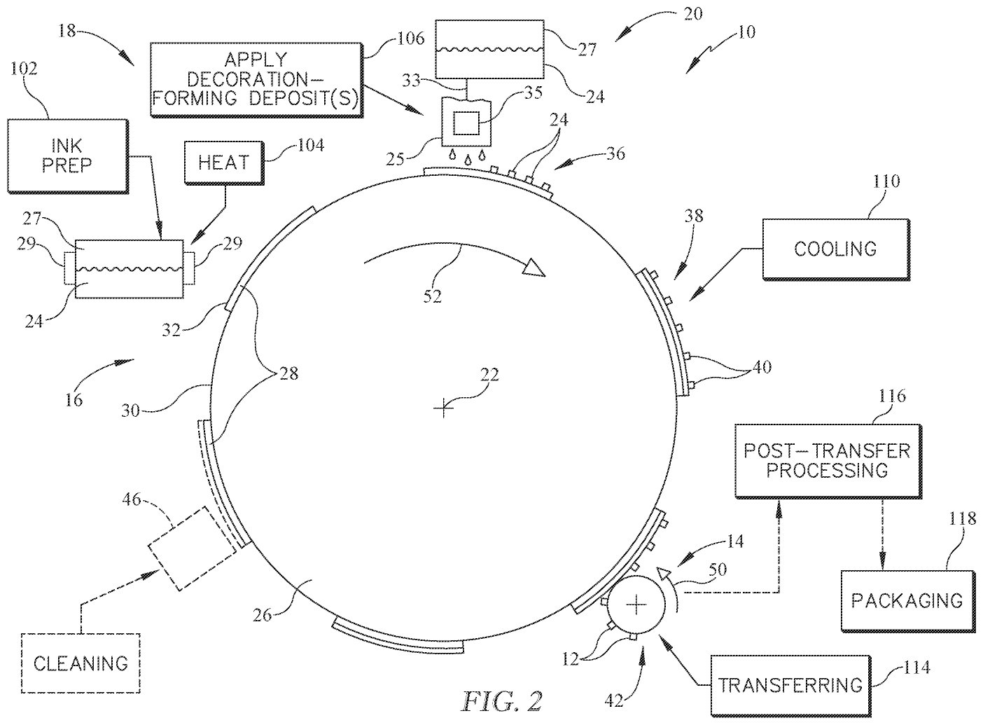

A print system 10 in accordance with the present disclosure is configured to form a decoration 12 on a polymeric article 14 through a digital printing process 100 as shown in FIG. 1. The print system 10 includes a rotary carrier 16, a printing unit 18, and a thermal-control unit 20 as shown in FIGS. 1 and 2. The rotary carrier 16 is configured to rotate about an axis 22 relative to both the printing unit 18 and the thermal-control unit 20. The printing unit 18 is configured to inject an ink solution 24I from an inkjet printer head 25 to provide a decoration-forming deposit 24 on the rotary carrier 16 for transfer to the polymeric article 14 later in the process 100. The thermal-control unit 20 is configured to control properties of the ink solution 24I, such as a temperature and a viscosity, before and after application of the ink solution 24I on the rotary carrier 16 to provide the decoration-forming deposit 24 with properties that allow the decoration-forming deposit 24 to be transferred to the polymeric article 14. The decoration-forming deposit 24 is transferred to the polymeric article 14 to form the decoration 12 on the polymeric article 14 with high resolution and clarity, at least in part, as a result of the temperature control provided by the thermal-control unit 20.

The printing unit 18 is, illustratively, a digital print unit that applies the ink solution 24I on the transfer unit 28 by ink jet printing, for example. In this way, the print system 10 provides non-blurry or high resolution decorations 12 on a plurality of polymeric articles 14 at a higher output rate than other digital printing systems and with shorter set-up, tear-down, and conversion times compared to other printing systems, such as dry offset printers or offset lithographic printers, for example. The thermal-control unit 20 is configured to change thermal properties of the ink solution 24I to cause the ink solution 24I to decrease viscosity prior to deposit on the rotary carrier 16 and to then increase viscosity prior to application on the polymeric article 14. This allows the ink solution 24I to be applied on the transfer unit 28 by ink jet printing and then transferred to the polymeric articles 14 via the transfer unit 28, rather than ink jet printing directly on the polymeric articles 14.

The rotary carrier 16 includes a support wheel 26 and a plurality of transfer units 28 (also called transfer blankets) coupled to a radially outer surface 30 of the support wheel 26 relative to the axis 22 as shown in FIG. 2. The support wheel 26 is a cylindrical roller that is configured to carry each of the transfer units 28 continuously through 360 degrees of rotation about axis 22. Each transfer unit 28 of the plurality of transfer units 28 may be made from polyvinyl chloride (PVC), urethane, or another type of polymeric material. Each transfer unit 28 is illustratively formed in the shape of an arcuate plate to conform to the outer surface 30 of the support wheel 26, and each transfer unit 28 is spaced apart circumferentially from each neighboring transfer unit 28 relative to axis 22. Individual applications of ink solution 24I are applied on each transfer unit 28 to provide the decoration-forming deposits 24. Each transfer unit 28 is configured to transfer the decoration-forming deposits 24 to a corresponding polymeric article 14 provide decoration 12 on the corresponding polymeric article 14 for each rotation of the rotary carrier 16. In some embodiments, the radially outer surface 30 of the support wheel 26 may be used as a single transfer unit 28 on which a plurality of decoration-forming deposits 24 are applied to provide decoration 12 on a plurality of polymeric articles 14.

The digital printing process 100 begins with a step 102 of preparing an ink solution 24I for deposit on the transfer unit 28 as shown in FIGS. 1 and 2. The step 102 may include pre-heating the ink solution 24I in a storage vessel 27 at a location spaced away from the rotary carrier 16. Preheating the ink solution 24I is configured to decrease a viscosity of the ink solution 24I, or thin the ink solution 24I, prior to deposit on the transfer unit 28 to form decoration-forming deposits 24. The step 102 of preparing the ink solution 24I may also include adding one or more additives to a base ink to change one or more characteristics of the ink including pigment, viscosity, or both.

The storage vessel 27 may be a storage bin, a conduit, a tank, a cartridge, or any other suitable vessel that can store fluid. The step 102 of pre-heating can be performed by conductive, convective, radiant heating, or combinations thereof using one or more heating units 29 positioned on, around, or in the storage vessel 27. The heating units 29 can include any one or more of a metal heating element, a ceramic or semiconductor heating element, a thick film heating element, a polymer PTC heating element, a composite heating element, a combination heating element system, hot air, hot liquid(s), combinations thereof, or any other suitable heating device.

In the illustrative embodiment, the ink solution 24I used in the process 100 includes or consists of a flexographic type ink that is comparatively used in offset printing applications and not with digital inkjet printing. In particular, the ink solution 24I includes or consists of an oligomeric ink containing both monomers and oligomers. Other inkjet inks may be monomeric inks that contain solely monomers and that are less viscous than flexographic inks. The process 100 consists of using a flexographic ink solution 24I with a high viscosity typically unsuitable for use with inkjet print heads but which has been pre-treated during step 102 for application in a digital printing process 100. One example of a suitable flexographic ink for use with process 100 is product ID RH1773455, also called LED OPAQUE WHITE, manufactured by Zeller+Gmelin Corporation located at 4801 Audubon Drive, Richmond, Virginia 23231 USA. Another example of a suitable flexographic ink for use with process 100 is product ID RH3271719, also called IDF PC BLACK BW8, manufactured by Zeller+Gmelin Corporation located at 4801 Audubon Drive, Richmond, Virginia 23231 USA. An example of an inkjet ink that is unsuitable for use with process 100 is product code USJET7029 manufactured by Sun Chemical Corporation North American Inks located at 135 West Lake Street Northlake, IL 60164. Some or all inkjet inks may be unsuitable for use with process 100 because they are less viscous than flexographic inks and tend to smear or slur when used with a rotary carrier 16 to decorate high volumes of articles.

One or more pumps 31 and/or conduits 33 are configured to transfer the pre-heated ink solution 24I from the storage vessel 27 to the transfer unit(s) 28 of the rotary carrier 16 after the step of preparing the ink 102 as suggested in FIGS. 1 and 2. The heating units 29 can be coupled to the conduit(s) 33 to heat the ink solution traveling therethrough during step 102. The conduit(s) 33 interconnect the storage vessel 27 and a print head 25 that injects the ink solution 24I toward the transfer unit 28 to apply the decoration-forming deposit 24 on the transfer unit 28.

The process 100 may further include a step 104 of heating the ink solution 24I using the print head 25 prior to application of the decoration-forming deposit 24 on the transfer unit 28 as shown in FIG. 1. The printer head 25 may include or be coupled to a heating unit 35 that is separate from the heating unit(s) 29. Including two steps of heating 102, 104 may increase efficiencies and/or throughput of the system 10 as a whole by expediting heating of the ink solution 24I to allow for faster application of the decoration-forming deposits 24 on transfer unit 28. In some embodiments, a transfer fluid may be applied on the transfer unit 28 and the ink solution 24I can be applied on the transfer fluid. One example of a process that uses a transfer fluid is described in U.S. Patent Application Publication No. 2022/0314677, filed Mar. 31, 2022, which expressly incorporated by reference herein in its entirety.

The steps 102, 104 of pre-heating the ink solution 24I and heating the ink solution 24I may lower the viscosity (i.e. thin) of the ink solution 24I either in combination with one another or individually. In one example, one or both of the steps 102, 104 lower the viscosity of the ink solution 24I to below 100 cP by heating the ink solution 24I to a temperature of at least 75° C.

The digital printing process 100 completes several steps at various angular positions relative to axis 22 as the support wheel 26 rotates about axis 22 as suggested in FIGS. 1 and 2. The digital printing process 100 includes a step 106 of applying the heated ink solution 24I on the transfer unit 28. The step 106 of applying the heated ink solution 24I may include applying the heated ink solution 24I with an ink-jet printer head 25 (e.g., a digital ink-jet printer head) or by ink-jet printing the heated ink solution 24I onto the transfer unit 28. The heated ink solution 24I forms decoration-forming deposit 24 when applied to the transfer unit 28 and is a mirror image of the decoration 12 that is transferred to the polymeric article 14 in one or more later steps. The decoration forming deposit 24 may include any arrangement or pattern of inks that form the decoration 12. The digital printing process 100 may include a plurality of sub-steps of applying the heated ink solution(s) 24I, for example, if different inks are applied to the transfer unit 28 at different angular positions relative to axis 22.

The digital printing process 100 includes a step 108 of rotating the rotary carrier 16 with the layer of transfer unit 28 and the decoration-forming deposit 24 from a first angular position 36 to a second angular position 38 as shown in FIG. 1. At the second angular position 38, the digital printing process 100 includes a step 110 of cooling the decoration-forming deposit 24 to provide a thickened decoration-forming deposit 40. The decoration-forming deposit 24 is cooled at step 110, in the illustrative embodiment, to increase a tackiness and/or viscosity of the decoration-forming deposit 24 to block wetting, setting, and/or mixing of the decoration-forming deposit 24 with the transfer unit 28 and to block overspreading of the decoration-forming deposit 24 across the transfer unit 28.

In the illustrative embodiment, at least one of the rotary carrier 26 and the transfer unit 28 is made from or consists of a conductive material that provides a heat sink to draw heat away from the decoration forming deposit 24 at step 110 and provide the thickened decoration-forming deposit 40 at the second angular position 38. In the illustrative embodiment, the transfer unit 28 includes aluminum loaded silicone to allow transfer of heat from the decoration-forming deposit 24 to the transfer unit 28. Other comparative rotary printing machines may include thermally insulative materials for their transfer unit, such as ethylene propylene diene monomer (EPDM), nitrile rubber, or styrene-butadiene rubber (SBR), or the like. In some embodiments, the step 110 may occur as a result of the decoration-forming deposit being exposed to ambient environment and passage of time, such as the time it takes for the decoration forming deposit to move to the polymeric article 14. In some embodiments, the step 110 of cooling the decoration-forming deposit 24 may include actively cooling the decoration-forming deposit 24 by one or more fans blowing air toward the decoration-forming deposit 24 between the first and second angular positions 36, 38. The decoration-forming deposit 24 may partially cure during the step 110 of cooling. The decoration-forming deposit 24 is not cured by any ultra-violet light sources during process 100 in some embodiments.

The digital printing process 100 includes a step 112 of rotating the rotary carrier 16 and the cured decoration-forming deposit 40 to a third angular position 42 as shown in FIG. 1. At the third angular position 42, the digital printing process 100 includes a step 114 of transferring the cured decoration-forming deposit 40 to a polymeric article 14. At step 114, the polymeric article 14 is brought into contact with the cured decoration-forming deposit 40 so that the cured decoration-forming deposit 40 transfers to the polymeric article 14. Only the decoration-forming deposit 40 is transferred to the polymeric article 14 and the transfer unit 28 remains on the transfer unit 28 for reuse in receiving additional decoration-forming deposits 24 and transferring those decoration-forming deposits 24 to other polymeric articles 14 as the steps of process 100 are repeated.

Illustratively, the polymeric article 14 is a container having a cylindrical or a tapered side wall (i.e. a side wall with a varying diameter from a top end to a bottom end of the article 14) as shown in FIG. 1. Digital printing to an article 14 with a tapered side wall may cause residual decoration-forming deposits 24 to smear or slur, thereby resulting in a blurry decoration 12 formed on the article 14. The digital printing process provided by the digital print system 10 reduces or eliminates smearing or slurring of the decoration forming deposit 24 when printing to articles 14 having a tapered side wall. In some embodiments, about 50% of the decoration-forming deposit 24 is transferred to a polymeric article with each rotation about axis 22. In some embodiments, digital printing process 100 results in all or substantially all of the decoration-forming deposits 24 being transferred to the article 14 from the transfer unit 28 at step 114 so that smearing and/or slurring does not occur. In some embodiments, the support wheel 26 and/or the transfer units 28 may have a sloped outer surface which is angled to match the tapered side wall of the polymeric article 14 to reduce or eliminate smearing and slurring.

The container rotates in a direction 50 opposite to a direction 52 of rotation of the rotary carrier 16 so that the decoration 12 is provided around a circumference of the side wall of the container or partway around the circumference of the side wall. In some embodiments, the polymeric article may include a sheet or another polymeric article having a planar surface, such as a closure, lid, or cap, on which the decoration 12 is provided.

The digital printing process 100 may include a step 116 of post-transfer processing of the polymeric article 14 with the decoration 12 applied thereon as shown in FIG. 1. The step 116 of post-transfer processing may include a step of curing the decoration-forming deposit 40 to provide the decoration 12 on the polymeric article 14. If the decoration-forming deposit 24 was not previously cured at least partially prior to the step 114 of transferring, the decoration-forming deposit 24 may be cured in the step 116 of post-transfer processing. In some embodiments, the polymeric article 14 having the decoration 12 formed thereon may be laminated, rolled, formed, or otherwise converted during the step 116 of post-transfer processing to provide a finished article 44 that is ready for use. Following the step 116 of post-transfer processing, the finished article 44 may be packaged 118 for storage or transportation.

Prior to being coated or decorated with the decoration forming deposit 24, 40, the polymeric articles 14 are formed in a step 120. Step 120 may be included in the digital printing process or may be separate from the digital printing process 100. The polymeric article 14 may be formed using any suitable forming method, such as, for example, rotary thermoforming, deep draw thermoforming, blow molding, injection molding, casting, molding on a tread of molds, flatbed thermoforming, etc. Once formed, the polymeric article 14 may be pretreated prior to receiving the decoration-forming deposit 24, 40 at step 114. Pre-treating the polymeric article 14 may include increasing a surface tension of at least the portion(s) of the polymeric article 14 that receives the decoration forming deposit 24, 40 at step 114. In one example, the surface tension of the polymeric article 14 is increased from less than 40 dyne/cm to greater than 40 dyne/cm. In some embodiments, the surface tension of the polymeric article 14 is increased from about 20 dyne/cm to greater than or equal to 40 dyne/cm. In some embodiments, a varnish is applied on the polymeric article 14 prior to step 114.

In some embodiments, any decoration forming deposit 24, 40 remaining on the transfer unit 28 after the step 114 of transferring may be cleaned from the transfer unit 28 as shown in FIG. 2. In such an embodiment, a cleaning system 46, such as a squeegee, scraper, or fluid-jet, for example, is included in the digital printing unit 10 to clear any decoration forming deposit 24, 40 remaining on the transfer unit 28 after the step 114 of transferring. However, the cleaning system 46 may not be needed with the digital printing unit 10 because the transfer unit 28 and the decoration-forming deposit 24 are selected based on their fluid properties relative to one another such that transfer and formation of the decoration 12 on the polymeric article 14 is accomplished through digital printing process 100. In this way, the polymeric articles 14 are decorated through digital printing means which provides a higher output rate than other digital printing processes. In the illustrative embodiment, the print system 10 provides decoration 12 on polymeric articles 14 at a rate of about 500 parts per minute using digital printing process 100.

Another digital printing process 200 is shown in FIG. 4. Digital printing process 200 is similar to digital printing process 100. Accordingly, similar reference numbers in the 200 series are used to indicate similar features between digital printing process 200 and digital printing process 100. The disclosure of digital printing process 100 is hereby incorporated by reference herein for digital printing process 200 except for differences described below.

A digital print unit 210 is configured to form decoration 212 on a polymeric article 214 through the digital printing process 200 as shown in FIG. 4. Digital print unit 210 does not include a rotary carrier, and instead includes a carrier 16 that advances a plurality of transfer units 228 in a linear manner between steps, for example. The digital printing process 200 completes several steps at various positions relative to a carrier 216 including a support 226 and a transfer unit 228 coupled to an upper surface 230 of the support 226. The digital printing process 200 includes similar ink preparing and heating steps 202, 204 to those previously described in process 100.

Instead of rotating the transfer units 28 about an axis, the digital printing process 200 includes a step 204 of advancing the carrier 216 including the transfer unit 228 along a conveyor from a first position 236 to a second position 238 as shown in FIG. 4. At the second position 238, the digital printing process 200 includes a step 206 of applying ink solution 224I on the transfer unit 28 using an inkjet print head 225 to form a decoration-forming deposit 224 on the transfer unit 228. The ink solution 224I may be heated, or thinned, prior to application on transfer unit 228 by one or more heating elements 229 on or around the storage vessel 227 and/or by one or more heating elements 235 in the inkjet print head 225.

At the second position 238 or between the first and second positions 236, 238, the digital printing process 200 includes a step 210 of cooling the decoration-forming deposit 24 in a similar manner to cooling step 110 described in process 100. The digital printing process 200 includes a step 212 of advancing the carrier 216 including the transfer unit 228 and the cooled decoration-forming deposit 240 to a third position 242 as shown in FIG. 4. At the third position 242, the digital printing process 200 includes a step 214 of transferring the cooled decoration-forming deposit 240 to a polymeric article 14. In some embodiments, the cooling step is not performed.

The digital printing process 200 may include a step 216 of post-transfer processing of the polymeric article 14 with the cured decoration-forming deposit 224 applied thereon as shown in FIG. 4. Following the step 216 of post-transfer processing, the finished article 44 may be packaged 218 for storage or transportation. Prior to being coated or decorated with the decoration forming deposit 224, 240, the polymeric articles 14 are formed in a step 220.

1. A method of digital printing on a polymeric article, the method comprising steps of
providing a rotary carrier including a support wheel and a transfer unit coupled to the support wheel for rotation about an axis with the support wheel,
providing an ink solution in a storage vessel,
pre-heating the ink solution in the storage vessel to provide a pre-heated ink solution,
transferring the pre-heated ink solution from the storage vessel to an inkjet print head,
heating the pre-heated ink solution in the inkjet print head to provide a fully-heated ink solution,
discharging the fully-heated ink solution on the transfer unit to provide a decoration-forming deposit at a first angular position about the axis,
rotating the rotary carrier, the transfer unit, and the decoration-forming deposit about the axis from the first angular position to a second angular position,
cooling, at least partially, the decoration-forming deposit after the step of applying the decoration-forming deposit on the transfer unit, and
transferring the decoration-forming deposit from the transfer unit to the polymeric article when the transfer unit is at the second angular position to provide a decorated article.

2. The method of claim 1, wherein the ink solution includes a flexographic ink.

3. The method of claim 2, wherein the ink solution includes an oligomeric ink having both monomers and oligomers.

4. The method of claim 2, wherein the flexographic ink has a viscosity above 100 cP prior to the step of heating and the step of heating is configured to lower the viscosity of the flexographic ink to below 100 cP.

5. The method of claim 4, wherein the step of heating the flexographic ink includes heating the flexographic ink to at least 75° C.

6. The method of claim 1, wherein the transfer unit includes a conductive material to cause the step of cooling by providing a heat sink that draws heat from the decoration-forming deposit toward the rotary carrier.

7. The method of claim 6, wherein the conductive material forming the transfer unit includes aluminum loaded silicone.

8. The method of claim 1, wherein the step of cooling includes actively cooling the decoration-forming deposit by blowing air on the decoration forming deposit.

9. The method of claim 8, wherein the transfer unit includes a conductive material and the step of cooling further includes drawing heat from the decoration-forming deposit toward the rotary carrier using the transfer unit.

10. The method of claim 1, wherein the ink solution includes an oligomeric ink having both monomers and oligomers,
wherein the oligomeric ink has a viscosity above 100 cP prior to the step of heating and the step of heating is configured to lower the viscosity of the flexographic ink to below 100 cP,
wherein the step of heating the oligomeric ink includes heating the oligomeric ink to at least 75° C., and
wherein the transfer unit includes a conductive material to cause the step of cooling by providing a heat sink that draws heat from the decoration-forming deposit toward the rotary carrier to raise the viscosity of the decoration-forming deposit above 100 cP prior to the decoration-forming deposit being transferred to the polymeric article.

11. The method of claim 10, further comprising a step of returning the transfer unit to the first angular position and applying a second dose of fully-heated ink solution on the transfer unit after transferring the decoration-forming deposit from the transfer unit to the polymeric article.

12. A method of digital printing on a polymeric article, the method comprising steps of
providing a carrier and a transfer unit coupled to the carrier,
providing an ink solution in a storage vessel,
decreasing a viscosity of the ink solution in the storage vessel to provide a thinned ink solution,
transferring the thinned ink solution from the storage vessel to an inkjet print head,
discharging the thinned ink solution onto the transfer unit to provide a decoration-forming deposit on the transfer unit,
moving the carrier, the transfer unit, and the decoration-forming deposit from a first position to a second position,
cooling, at least partially, the decoration-forming deposit after the step of applying the decoration-forming deposit on the transfer unit, and
transferring the decoration-forming deposit from the transfer unit to the polymeric article when the transfer unit is at the second position.

13. The method of claim 12, wherein the ink solution includes a flexographic ink.

14. The method of claim 13, wherein the ink solution includes an oligomeric ink having both monomers and oligomers.

15. The method of claim 13, wherein the flexographic ink has a viscosity above 100 cP prior to the step of decreasing the viscosity of the ink solution and the step of decreasing the viscosity of the ink solution is configured to lower the viscosity of the flexographic ink to below 100 cP.

16. The method of claim 15, wherein the step of decreasing the viscosity of the flexographic ink includes heating the flexographic ink to at least 75° C.

17. The method of claim 12, wherein the transfer unit includes a conductive material to cause the step of cooling by providing a heat sink that draws heat from the decoration-forming deposit toward the rotary carrier.

18. The method of claim 12, wherein the step of cooling includes actively cooling the decoration-forming deposit by blowing air on the decoration forming deposit.

19. The method of claim 12, wherein the ink solution includes an oligomeric ink having both monomers and oligomers,
wherein the oligomeric ink has a viscosity above 100 cP prior to the step of decreasing the viscosity of the ink solution and the step of decreasing the viscosity of the ink solution is configured to lower the viscosity of the flexographic ink to below 100 cP,
wherein the step of decreasing the viscosity of the ink solution the oligomeric ink includes heating the oligomeric ink to at least 75° C., and
wherein the transfer unit includes a conductive material to cause the step of cooling by providing a heat sink that draws heat from the decoration-forming deposit toward the rotary carrier to raise the viscosity of the decoration-forming deposit above 100 cP prior to the decoration-forming deposit being transferred to the polymeric article.

20. The method of claim 19, further comprising a step of returning the transfer unit to the first position and applying a second dose of thinned ink solution on the transfer unit after transferring the decoration-forming deposit from the transfer unit to the polymeric article.
